(19) United States
(12) Patent Application Publication
(10) Pub. No.: US 2004/0216163 A1
(43) Pub. Date: Oct. 28, 2004

(54) System and method for digital content management and distribution of content streams within a theatre environment

(76) Inventor: Shawn Whitcomb, Overland Park, KS (US)

Correspondence Address: LATHROP & GAGE LC, 2345 GRAND AVENUE, SUITE 2800, KANSAS CITY, MO, 64108, US

(21) Appl. No.: 10/423,596

(22) Filed: Apr. 25, 2003

(51) Int. Cl. H04N 7/18; H04N 7/16

(52) U.S. Cl. 725/74; 725/82

(57) ABSTRACT

The present invention is directed to a central content management system for providing digital content to one or more movie theatre complexes, each complex having one or more electronic display devices. The system includes a central management content assembly for assembling and transmitting the digital content and an instruction set associated with the digital content; a theatre complex assembly located at each movie theatre complex for receiving, storing and queuing the data pursuant to the instruction set, and a audio/video/graphics matrix for routing the digital content to one or more electronic display assemblies pursuant to the instruction set. The electronic display assemblies can include screens of a movie theatre, video walls, plasma screens, monitors, or a combination thereof.

### FIELD OF THE INVENTION

The present invention relates generally to a centralized content management system within a theatre environment and, more specifically, to a centralized content management system that provides for the distribution of video/audio/graphics/message streams from a central location to both audio and video devices, such as plasma with speakers, projection systems and audio receivers, remotely located at theatre complexes. The content streams are distributed on a schedule either on content-owner preselected criteria, such as date, location/display device, time of day, 35 mm film rating, 35 mm film title or determined based on the local point of sale feature presentation schedule.

More specifically, the invention allows the content owner or agncy to specifically target display devices based on a variety of criteria, including but not limited to date, time of day, 35 mm film rating, 35 mm film title. The invention uses externa/internal triggers to distribute the associated video/audio/graphics/message streams from a central point to the designated device. The present invention relates to display and audio devices within a theatre environment, specifically a movie theatre or cinema.

### BACKGROUND

Advertisement and accompanying information is typically provided to cinema audiences via two forms: slide (also called fixed stock) and movie (also called rolling stock). These two forms of advertising are presented to movie theater audiences prior to the feature presentation. Typically, fixed stock is presented when the auditorium lights are dimly lit and moviegoers are entering the theater to take their seats during the seating period. Rolling stock is typically presented when the lights have been lowered and most of the moviegoers are seated during the pre-feature period.

Fixed stock is inherently static whereas rolling stock is inherently time-variant or dynamic. The cost of production for fixed stock is significantly lower than the cost of production for rolling stock. With a lower cost of production and a smaller target audience, fixed stock is a significantly less expensive form of advertising than rolling stock. Both forms of stock may be used to convey non-advertising content as well as advertising content. Non-advertising content includes, but is not limited to, public service messages and content for the purpose of entertaining. Particularly in the case of fixed stock, entertaining content is interleaved with advertising content. This serves the purpose of filling unsold advertising slots and enhances the appeal of the overall presentation to the moviegoer audience.

In the cases of both fixed stock and rolling stock, the message takes a physical form, e. g., slides or film. A physical copy of each slide or film is required in every theater screen location. Distribution of the physical materials is repetitious and costly.

Systems have been disclosed for transmitting digital advertising or movie content to movie theatres. For example, U.S. Pat. No. 6,424,998 is directed to a system that permits video (e.g., movies and advertising) or still-image content to be displayed on networked electronic displays at selected times according to dictates of the customers of the system. The patent discloses a system in which a movie theatre operator orders movies (or advertising content) in digital form for display on selected screens at their theaters at selected times. The movie theater operator has the ability to review movies that are. available in digital form and thereafter schedule and purchase a movie for display on the digital movie screens located at the customer's movie theater. The disclosed system is a “server-to-server” network in which the transmission from the remote central server communicates with a server associated with each electronic display assembly (such as a projector or lobby plasma display).

Published PCT application, PCT/US00/22105, is directed to a computer-based system for scheduling, assembling and rendering digital content and specifically advertising, to movie theater audiences via movie theater screens. The advertising is received in digital form from the content providers over the Internet or by other digital means. The advertising is scheduled and staged, and then the content is assembled into a presentation according to the schedule and electronically rendered to its intended audiences. The system includes a central content provider, a set of servers that are connected to the central provider via the Internet and a set of client assemblies. The client assemblies, which include a personal computer and a projector, are housed in the theatre buildings that they serve. The servers receive, store and assemble message content for presentation. The client assemblies are tasked with rendering message content. Each client assembly includes a personal computer that is connected to the system's Intranet and a digital projector through which the personal computer renders the presentation onto a theatre screen. For the multi-screen embodiment, each client assembly is connected to a sub-net that in turn is connected to a local PC sub-net server. The local sub-net server acts as a single point of contact to the system's Intranet. This arrangement thus likewise functions as a server-to-server system, wherein the central server communicates through a sub-net to a server associated with each digital projector for each particular screen.

A disadvantage with the above-described server-to-server systems is that it is cost prohibitive and limits the implement ability for multi-screen environments. It would be advantageous to have a central server to theatre server system whereby the theatre server controls the distribution of the particular digital content to the multiple screens of the theatre.

### SUMMARY OF THE INVENTION

The invention method includes a system for creating, trafficking and distribution of digital content and information to a theatre complex. The method includes creating and encoding the content using MPEG, MPEG2, or MPEG4 compression or graphics, then storing that content on a transmission server for delivery to theatre(s). A method of scheduling content criteria at a remote location via the Digital Content Scheduling Software and delivered separately or in conjunction with the associated content electronically or manually loaded onto the location based Catch Server. The Digital Content Scheduling Software allows the user to enter the scheduling criteria such as location, time range, date range, 35 mm film title, 35 mm film rating, specific electronic display device, and other criteria as necessary. The content and associated schedule is then transmitted/or loaded on DVD and transported to the DTDS Theatre Catch Server.

The preferred invention configuration at the theatre complex includes a Theatre Catch Server, Central Theatre Server, Satellite Receiver, Audio/Video/Graphics Matrix, Uninterruptible Power Supply, and Network Components such as hubs, switches, routers. Each auditorium will have an Operator Keypad Interface with an LCD display device for monitoring and manual override. All electronic devices are networked to the Central Server for monitoring and control. The Central Theatre Server is dedicated to the management of that locations digital content and monitoring/importing the 35 mm film schedule from the point of sale scheduling system. At the designated time and based on the pre-determined criteria and associated outside variables impacting the system, the Central Theatre Server will stream audio/video/graphics/messages content to Audio/Video/Graphics Matrix. The Central Theatre Server will instruct the Audio/Video/Graphics Matrix to switch the content stream input to the appropriate output to one or many electronic display/audio devices. The Central Theatre Server captures the content id, time, date, location, and electronic display device in which content is playing back on and stores this data on the Central Theatre Server. Upon collecting this data, it is brought back to a central storage location via an electronic network connection (i.e. VSAT, Internet broadband, frame relay network) and uploaded into a central database at a designated location for safe keeping, reporting, and analysis.

In addition, the invention will control and manage digital content related to and including feature presentation. The Central Theatre Server contains the most current point of sale scheduling instructions for the 35 mm films, and based on this information it assembles digital content dynamically against this information and other sources of information related to and including the feature presentation. Once a scheduling change is relayed to the Central Theatre Server it determines if the digital content is a feature presentation or pre-feature or other. If it is feature presentation, the system then determines which feature presentation playback device the content resides upon. If none, the Central Theatre Server determines the time necessary and the start time to initiate the moving of digital content to the designated feature presentation playback device. The Central Theatre Server monitors the moving of digital content and to ensure no errors and content is ready for playback at the instructed time, based on the point of sale scheduling instructions. If it is pre-feature presentation, the system uses the scheduling criteria against the theatre schedule and plays back content loaded on the Central Theatre Server to the associated display device(s).

In addition, the invention will allow a local authorized operator to schedule pre-arranged alternative content programming, which will be delivered via electronically. The scheduling criteria will include which electronic display device, date, time, and a pre-determined location of the content. (I.e. Satellite channel) The Central Theatre Server will assemble the given instructions and initiate the content playback and route (via Audio/Video/Graphics Matrix) to the specified electronic display device at the instructed date, time. The invention provides seamless content programming between the pre-arranged alternative content programming and the remote pre-scheduled content playback.

### BRIEF DESCRIPTION OF THE DRAWINGS

The invention is best illustrated using the following figures along with the proceeding detailed description of the invention. The proceeding detailed description will reference these figures to provide a complete illustration of the invention and methods used.

FIG. 1 is a block diagram showing the principal components of a macro level construct of the present invention.

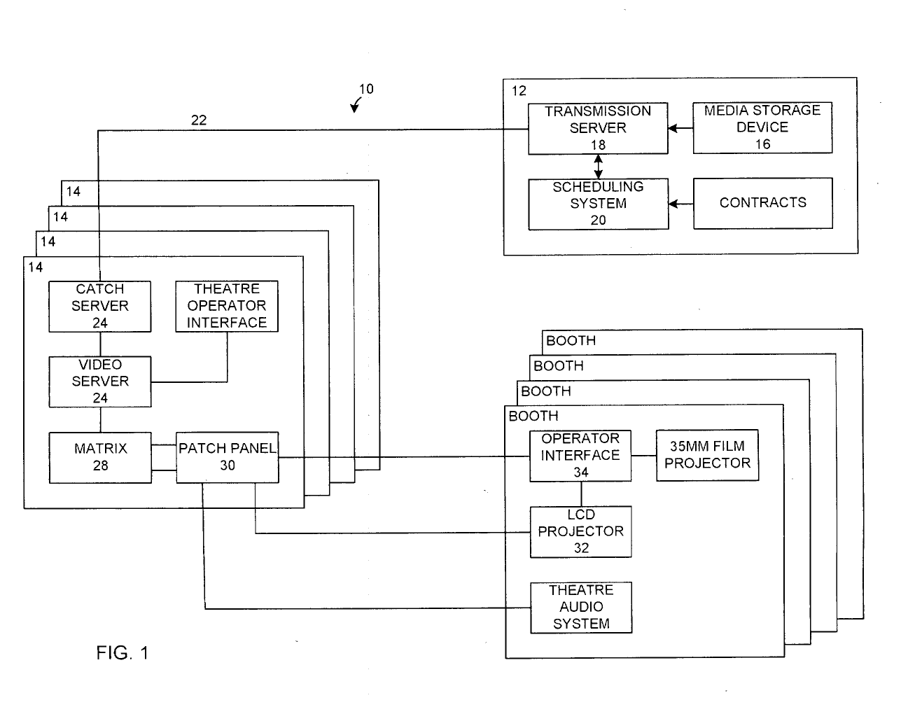

FIG. 2 is a block diagram showing the components of the detailed components of the Central Theatre Server and associated central components of FIG. 1.

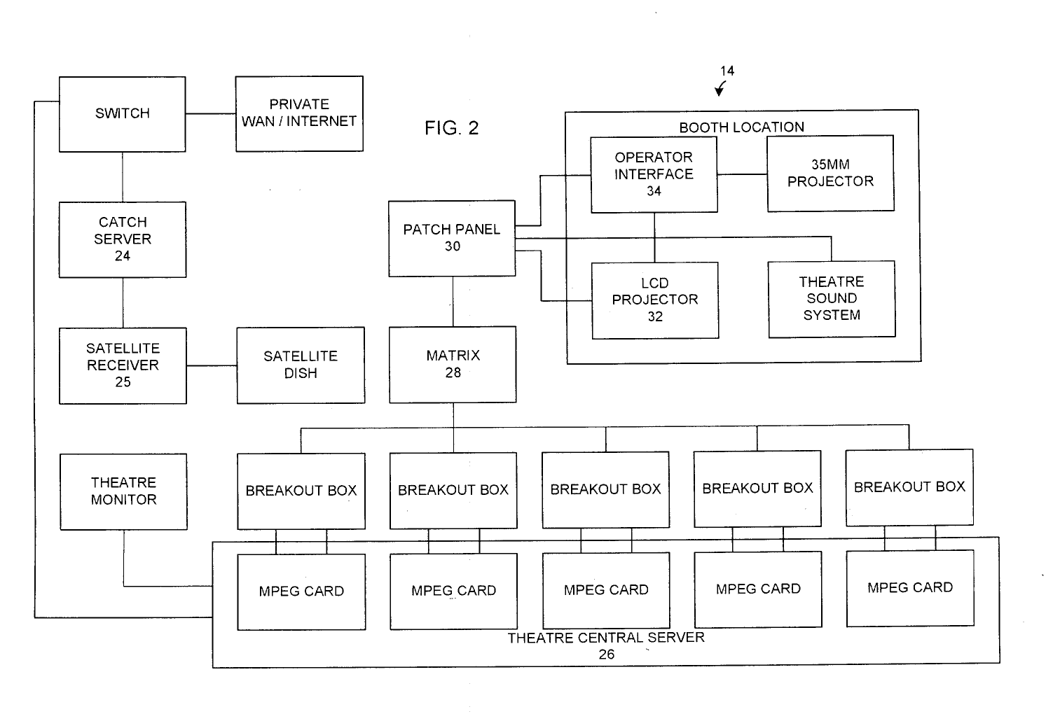

FIG. 3 is a flow diagram showing the method of creation, scheduling and distribution of pre-feature content delivered via satellite to the Theatre Catch Server at the theatre location in accordance with the present invention.

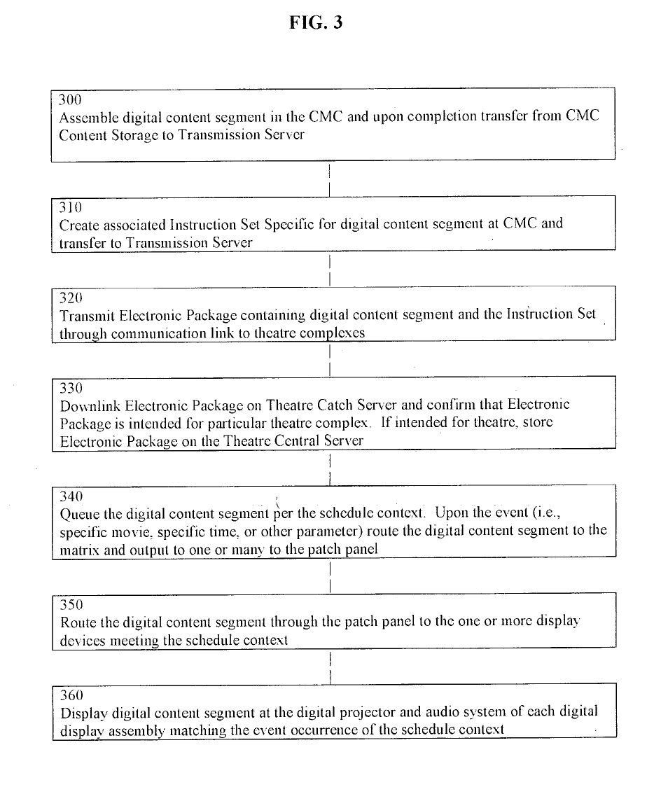

FIG. 4 is a flow diagram showing the method for the distribution of digital pre-feature content to individual electronic display devices within a theatre complex in accordance with the present invention.

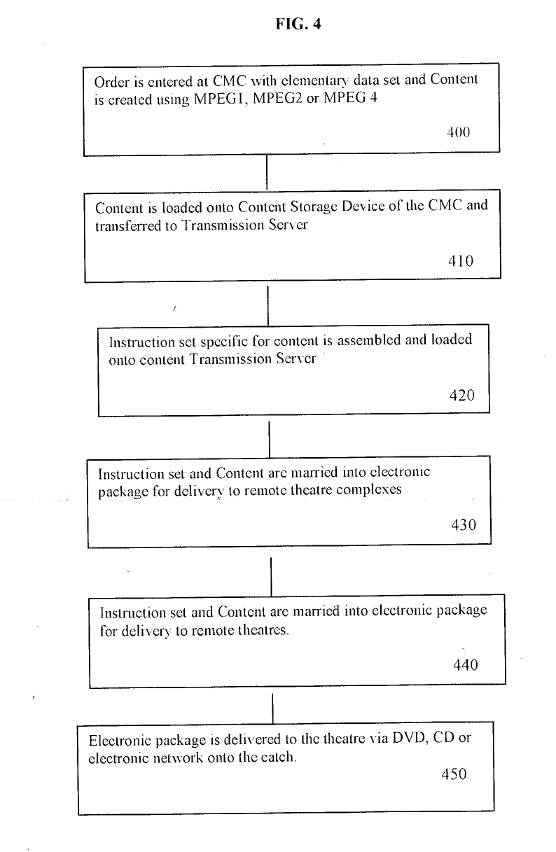

FIG. 5 is a flow diagram showing the method of managing and distribution of alternative programming content delivered via satellite on screen(s) of a theatre complex in accordance with the present invention.

FIG. 6 is a flow diagram showing the method of managing digital feature presentation and related content for on screen(s) presentation in a theatre complex in accordance with the present invention.

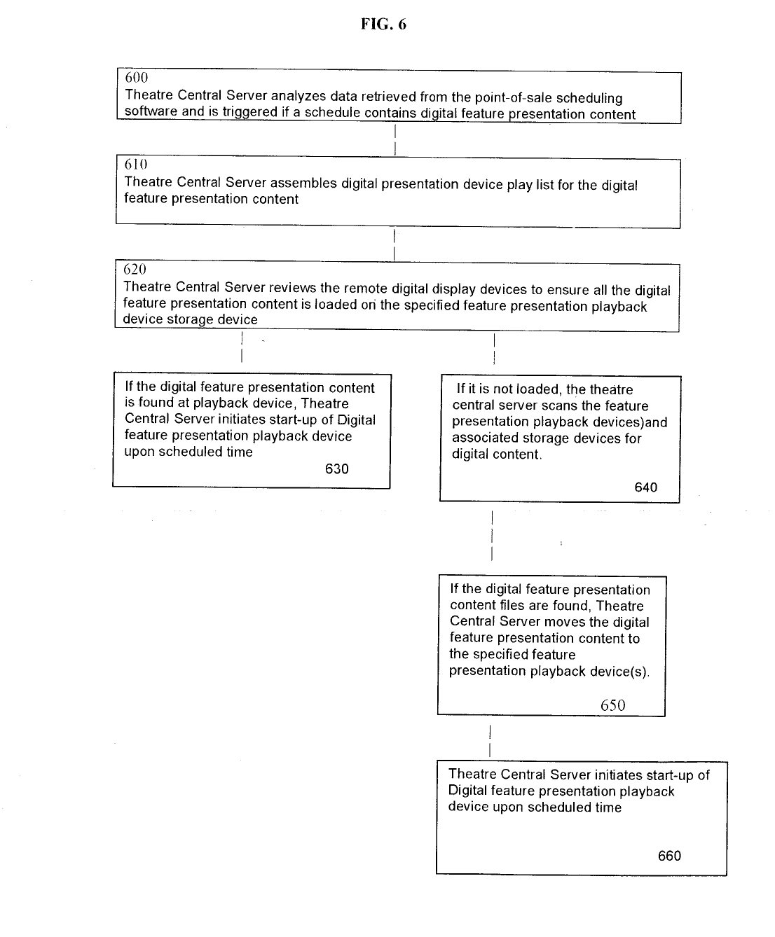

FIG. 7 is a block diagram showing the components of a subsystem of FIG. 1 within an auditorium of the theatre complex showing the operator interface of the present invention.

FIG. 8 showing the method of creation, scheduling and distribution of digital content/graphics delivered via satellite to the theatre location for display on a lobby display device in accordance with the present invention.

### DETAILED DESCRIPTION OF THE INVENTION

In accordance with a preferred embodiment of the present invention, a central content management system 10 is provided for the purpose of conveying digital video/audio/graphics/message content from one or more Content Management Centers (CMC) to audio and video devices at remote movie theatre complexes and for controlling associated networked devices related to the audio and video devices. The system 10 includes one or more CMCs 12, each primarily tasked with receiving, storing, and assembling digital content for distribution to theatre complexes and a plurality of theatre complex assemblies, shown generally at 14, primarily tasked with storing and queuing the digital content received from the CMC 12.

The CMC 12 comprises a content storage device 16, a content transmission server 18, a content scheduling system 20 and a communication link 22. In one embodiment of practicing the method of the present invention, which will be described in greater detail below, a digital content stream related to an order is created using industry standards MPEG1, MPEG2, or MPEG4. The digital content stream may be encoded or not encoded and can include audio, video, graphics, message, or combinations thereof. This content along with associated elementary (metadata) data, described in greater detail hereinafter, are stored on the content storage device 16 of the CMC 12. An instruction set specific to the digital content is assembled using the content scheduling system 20, which marries the content and the set of instructions into an electronic package and this electronic package is transferred to the content transmission server 18 for delivery to remote theatre complexes. The content scheduling system 20 is preferably implemented through software or, alternatively, one or more system components.

The transmission server 18 of the CMC 12 includes a staging area and a transmission assembly for storing the electronic package. The transmission server 18 preferably includes a 1 GHz or faster processor, a minimum of 512 Mb of RAM, and persistent data storage device (e. g. magnetic disk). The transmission server 18 is further configured with fail-safe protection that provides uninterrupted service in the event the building should have a loss of power. Computers are available from IBM, HP, Dell, and many other vendors that will meet the minimum specifications.

The CMC communication link 22 transmits the electronic package to each theatre complex. The communication link 22 may take a number of forms, with it being understood that any form, or combination thereof, may be used at various locations within the network. In one preferred embodiment of the invention as used in association with the distribution of the electronic package, a satellite uplink/downlink system is used to transmit high speed, compressed, either real time or non-real time data. The preferred method of delivery is via satellite, but other methods can also be used such as frame relay, Internet broadband, dedicated network connections (T1, T3), or burned to a CD, DVD, hard media.

The electronic package is delivered to one or more of the plurality of theatre complex assemblies 14. Each theatre complex assembly 14 preferably includes a satellite receiver 25 for downloading the electronic package, a theatre catch server 24, a central server 26, an audio/video/graphics matrix 28, a distribution patch panel 30, one or more electronic display devices 32, and operator interface devices 34. The electronic package is loaded onto the theatre catch server 24, which opens the electronic package. The catch server 24 preferably includes a 1 GHz or faster processor and a minimum of 256 Mb RAM. The theatre central server 26 is a centrally located high-end server that can output up to 24 unique outputs of MPEG1, MPEG2, MPEG4 decoded content streams, or graphics. The server outputs both audio and video, or graphics handling a variety of formats for Standard Definition to High Definition. The preferred output goes from the back of the server to a break-out box which requires each break out box to be genlocked to a common source. High-end and mid-level server equipment is available from IBM, HP, Dell, and many other vendors for the theatre catch server 24 and the theatre central server 26.

The theatre central server 26 communicates to the audio/video/graphics matrix 28 via RS232 protocol or TCP/IP. The audio/video/graphics matrix 28 is preferably mounted in the same equipment rack as the theatre central server 26 and is primarily tasked with routing digital content streams and graphics to the instructed output. The number of inputs and outputs of the audio/video/graphics matrix varies depending on the number of screens in a particular theatre complex. Preferably, the audio/video/graphics matrix 28 has multiple inputs (i.e. 20 inputs) and an output for every electronic display device 32. The audio/video/graphics matrix 28 is preferably a modular-based matrix having modular cards, and redundant power supplies to provide minimum downtime.

The matrix 28 output is routed to the distribution patch panel 30, which provides the route between the matrix and a particular electronic display device 32. The distribution patch panel 30 provides a central termination point for all the cabling which is routed throughout the entire theatre complex. It includes but is not limited to audio, video, RJ45 (CAT5, CAT5e, CAT6), and fiber.

The electronic display device 32 may be an audio device, video display device, graphics display device, or a display device contenting both audio, graphics, and video. One or more of the suitable type of display device 32 may be utilized in the theatre complex. Examples are as follows:

A large, seamless, flat screen LED display having relatively low power LED's suitable for the low ambient light conditions of a movie theater.

A high resolution, full color display utilizing high power LED's providing a light source for an LCD shutter-type screen.

A projection system based on the digital light processing (DLP) technology developed by Texas Instruments.

Reflective LCD technology developed by Sanyo and Reflective Technologies can provide a completely digital, flat panel, full color movie screen.

The electronic display device may be located in a theatre auditorium or alternatively, it may be a lobby display device to present digital content segments/graphics in high traffic areas located in and around a theatre complex.

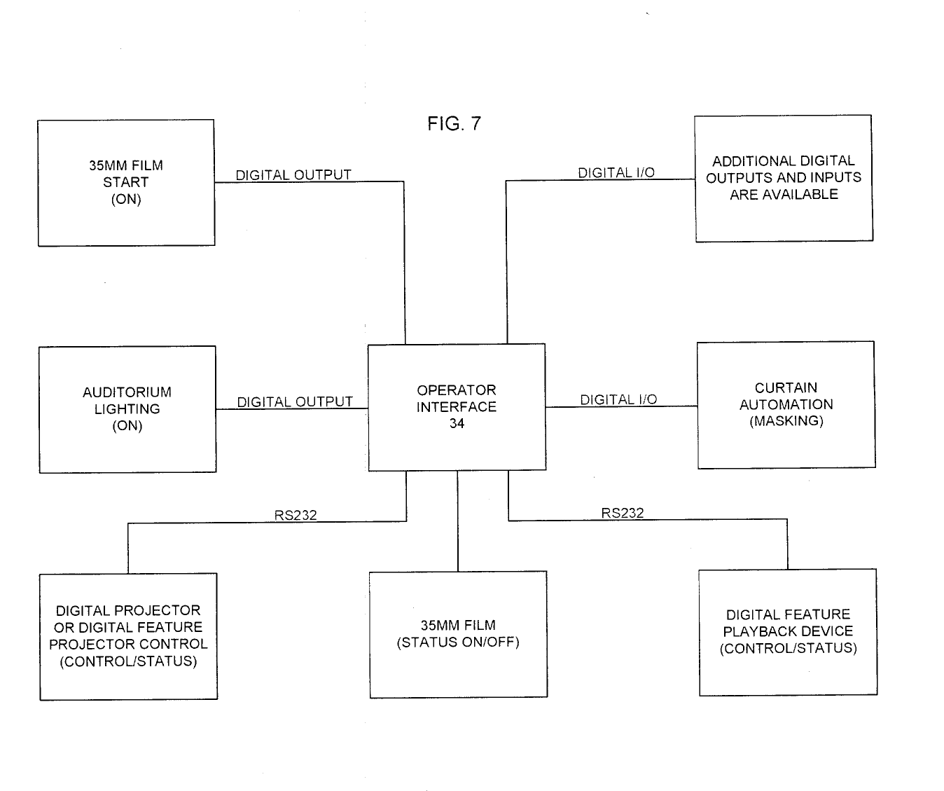

An operator keypad interface 34 is associated with each auditorium electronic display device 32. Preferably the operator keypad interface is located in each theatre booth and is primarily tasked with interfacing with the equipment within the theatre booth (FIG. 7). The operator keypad interface 34 has both digital inputs and outputs to control and monitor electronic devices within the booth, such as 35 mm film start/stop, lighting control, curtain masking, audio settings. The preferred operator keypad interface 34 has a LCD and a touch screen, and communicates to the theatre central server 26 via TCP/IP, but it is to be understood that other communication methods may also be used without departing from the scope of the invention. In addition, the operator keypad interface 34 provides booth specific functionality such as theatre operator manual control over theatre central server 26 instructions; real-time monitoring specific booth components; current content play list; and alerts and alarms related to the system. The operator keypad interface 34 provides a manual override for the system and enables a booth operator to manually start a digital content stream provided that the 35 mm film projector is not in operation. The operator keypad interface 34 provides a common control for operating the digital projector, so regardless of the digital projector equipment the operator can modify projector parameters and settings to suit their needs. The operator keypad interface 34 is provided with multiple levels of security in order to access the system.

In operation, the system of the present invention enables several methods of digital content management inside the theatre complexes. Specifically, the system enables (1) the scheduling, distribution, and management of digital content streams to electronic display devices 32; (2) the scheduling, distribution, and management of digital alternative content streams to electronic display devices 32; and (3) the scheduling, and management of a digital feature Presentation Content within the theatre complex.

Digital Content Streams to Electronic Display Devices

The following method describes in detail the processes in which content is prepared, stored, scheduled, and distributed to the theatre location(s). The described processes are related to a remote location other than the theatre location, preferably at the Content Management Center (CMC). At step 300, the process is initiated by entering an order into the system with an elementary (metadata) data set such as contract number, content id, description, content owner (client), type of programming, start date, end date, purge date, content source, and audio only. The entry of such an order is well known in the art and will not be described in detail. The content related to the order is created using industry standards MPEG1, MPEG2, MPEG4, or graphics and is identified by using the content id as the filename for that particular piece of content. This content is loaded onto the content storage device 16 of the CMC 12 and is ready for processing to the theatre location(s).

Once the order is identified as a completed order, the content is transferred from the content storage device 16 to the content transmission server 18. The instruction set is assembled at step 310 using the digital content scheduling system 20, preferably software, and loaded onto the content transmission server 18. The digital content scheduling software allows the operator to create a set of instructions specific to a piece of content which establishes the criteria based on the order contract number. The order contract number pulls the information for the instruction set and can be modified if necessary prior to finalizing the set of instructions. Some of the data that may be modified are start date, stop date, content ID, duration (calculated by examining the content), theatre ID, section ID (if a theatre complex is broken into sections), description of the content, content type, purge date, 35 mm film title, exclusions and inclusion for ratings, time of day, distributed, movie title (all items associated to 35 mm film). In addition, the operator sets the delivery instructions for this order.

The digital content scheduling software 20 marries the content using the content ID and the set of instructions into an electronic package for delivery. At step 320, the package is delivered at the designated time or, alternatively, immediately depending on the operator's set of instructions for delivery. The communication link 22 for transmitting the electronic package to each theatre complex may take a number of forms, with it being understood that any form, or combination thereof, may be used at various locations within the network. In one preferred embodiment of the invention as used in association with the distribution of the electronic package, a satellite uplink/downlink system is used to transmit high speed, compressed, either real time or non-real time data. Each theatre complex is in communication via a satellite downlink and has a decoder and a theatre catch server 24. The preferred method of delivery is via satellite, but other methods can also be used such as frame relay, Internet broadband, dedicated network connections (T1, T3), or burned to a CD, DVD, hard media. The electronic package is delivered to the theatre and loaded onto the Theatre Catch server 24 located at the theatre's facility.

At step 330, the theatre catch server 24 opens the package and processes the theatre location identification of the electronic package to determine if it is be delivered to this particular theatre location. If not, the theatre catch server 24 destroys the electronic package. If so, the theatre catch server 24 determines the structure of the electronic package by identifying the set of instructions; and the digital content.

Once the electronic package is verified and validated for this location and for the content, an operator from a remote location receives electronic verification that the electronic package was delivered and placed properly onto the particular theatre's catch server 24. The electronic verification is delivered over a backhaul channel method of communication.

The theatre central server 26 detects that a new electronic package has arrived by periodically polling the theatre catch server 24. Upon notice of an electronic package being available, the theatre central server 26 processes the set of instructions and stores data items into a database on the theatre central server. Secondly, if digital content is part of the package, the theatre central server 26 stores the digital content to a designated location on a hard disk array attached to the theatre central server. The theatre central server 26 processes the new data in the database to create a new schedule, if necessary, using the new set of instructions referencing the digital content as shown in step 340.

The theatre central server 26 is primarily tasked with the management of storing digital content, playback of digital content and assembling a set of theatre-specific instructions based on multiple outside variables. The following detailed description outlines the method as it relates to a theatre auditorium. The theatre central server 26 polls the theatre's point-of-sale scheduling system, such as the scheduling software supplied by Radiant Software, to obtain the most current movie schedule for that theatre location. The theatre central server 26 monitors the point-of-sale scheduling system for an event such as changes/updates to the movie schedule time changes, additions/updates/deletions to the movie title, distributor, rating changes, or assignment of movies to individual auditoriums. If triggered by this type of change in status, the theatre central server 26 downloads and imports the point-of-sale scheduling system changes into its central database located on the theatre central server.

This event triggers the theatre central server 26 to evaluate any changes for that current day and begins to re-assemble the changes into a new play list. Thus the digital content segment follows a change in screen location, movie time or other parameter. For example, if the screen location for a particular movie is changed and this is reflected in the point-of-sale scheduling system, the digital content is automatically updated in the appropriate play list specified by the new screen. Preferably at the beginning of each day and at the end of a point-of-sale scheduling system change or update, a play list is assigned to each electronic display device 32 inside the theatre central server 26's database. The play list remains in force until any further point-of-sale scheduling system change or update occurs.

The theatre central server 26 uses the point-of-sale scheduling system criteria combined with a set of detailed instructions stored in the theatre central server database to determine the play list associated with each electronic display device 32. A play list is created for each programming segment. The system is not limited on the number of programming segments. The play list includes items such as content identification, sequence number, duration, contract identification, and description. The theatre central server 26 can assemble a plurality of these play lists for a specific electronic display device 32.

At a pre-determined time, the theatre central server 26 determines a digital content start time for a specific electronic display device 32 by adding up all play list durations related to a specific electronic display device and subtracting this play list duration from the next movie start time. At step 350, the theatre central server 26 initiates playing the correct play list digital content using the high end video/audio/graphics cards (decoding MPEG, MPEG2, or MPEG4) installed in the theatre central server 26 to create the stream of digital content or graphics.

Simultaneously, the theatre central server 26 communicates to the operator keypad interface to ensure that a pre-determined set of criteria is met, such as 35 mm film projector off, digital projector on, masking set, audio switches set. The theatre central server 26 communicates to the audio/video/graphics matrix 28 to route the stream of digital content to the specified electronic display device 32 from the hard disc array of the theatre central server 26.

The audio/video/graphics matrix 28 sends the stream of digital content to a centrally located distribution patch panel 30 at step 350, which then routes it to the electronic display device 32 for display (step 360). Specifically, a theatre auditorium processes the video content from the stream of digital content on a digital projection device onto the auditorium screen. The audio portion of the stream of digital content will be routed to a sound processor device and then sent into the auditorium for listening. The audio/video/graphic matrix 28 allows the system to route streams of digital content from one input to one output; or from one input to many outputs from the theatre central server 26. The audio/video/graphics matrix 28 enables the mixing of a stream of audio and a different stream of video or graphics into one output. An example of this functionality is demonstrated best in using foreground music (audio stream) with an independent video stream. The system can also provide voice-over programming, which entails combining a video stream with a separate audio stream to one or many outputs for the same duration.

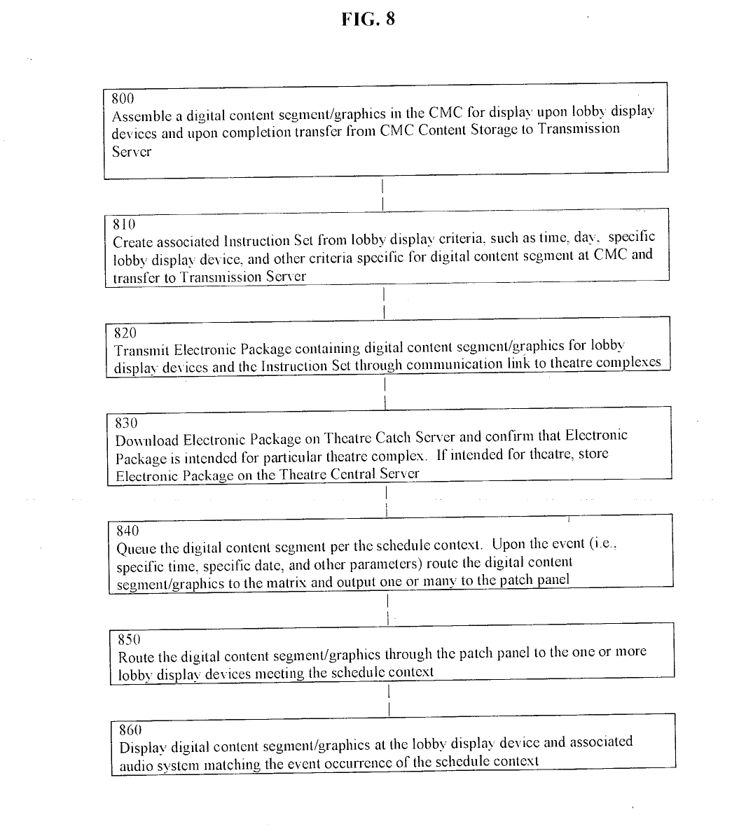

As shown in FIG. 8, the above-described method operates likewise for creating, scheduling and displaying content on lobby display devices such as plasma screen in high-traffic areas of the lobby of a particular theatre complex. The method steps (800-850) are the same as previously described, except that the digital content/graphic segment is routed through the matrix and patch panel to a particular lobby display device. In addition, this content can be managed remotely as described above thru the CMC or locally thru a centralized operator station.

Live Digital Alternative Content Streams to Electronic Display Devices

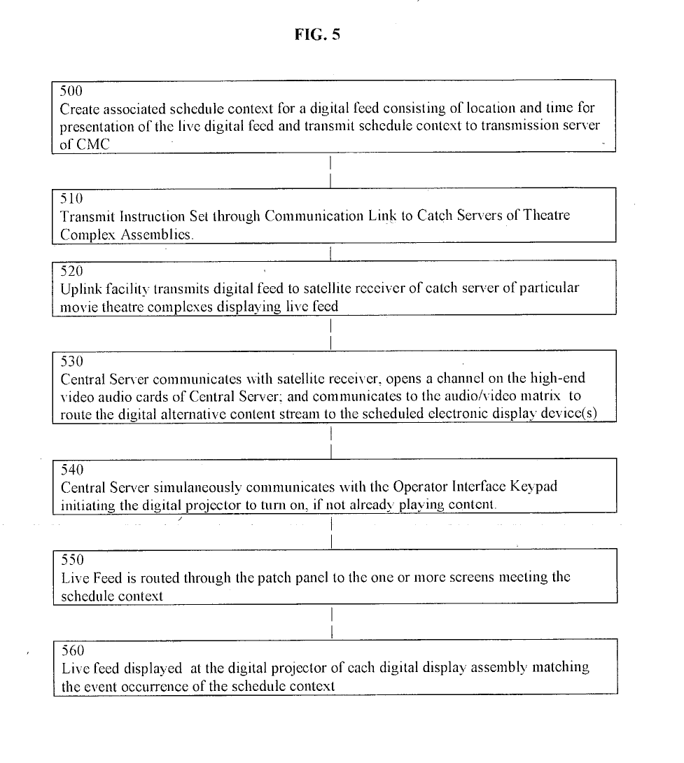

In addition, the system of the present invention enables the ability to schedule and route content that is not stored at the local theatre complex assembly 14 (FIG. 5). This can be scheduled both remotely and locally by an authorized operator of theatre central server 26. If the event is scheduled locally, the digital content management system is used to add an event and indicate that the event is a pass-through event. The date, time, channel (if satellite) and specific Electronic Display Device(s) 32 is entered to route the alternative digital content.

If scheduled remotely, an authorized operator schedules the digital alternative content stream using the digital content scheduler system to include information such as event, description, channel (if satellite), date, time, and specific electronic display device(s) 32 in which to route the digital alternative content (Step 500). The set instructions are then sent to the digital transmission server 18 and assembled for delivery to the theatre location via satellite (Step 510).

A live broadcast feed is received at the uplink facility providing service to the theatre complexes. The uplink facility transmits the live broadcast feed to the predetermined theatre complexes (Step 520). The satellite receiver receives the live broadcast feed. At the specified date and time, the theatre central server 26 communicates to the satellite receiver via RS232 or TCP/IP; opens a channel on the high-end video audio cards; and communicates to the audio/video/graphics matrix 28 to route the digital alternative content stream to the scheduled electronic display device(s) 32 (Step 530). The theatre central server 26 also communicates with the operator interface keypad initiating the digital projector to turn on, if not already playing content (Step 540). If playing content, a smooth transition will be made between the current Digital Content and the Digital Alternative Content stream and display the live broadcast (Step 550).

Digital Feature Presentation Content Management

In addition, the system of the present invention provides the capability to centralize or locally manage the digital feature presentation and associated trailer content which is displayed on an auditorium specific feature presentation playback device. When analyzing the data retrieved from the point-of-sale scheduling software, the theatre central server 26 is triggered if a schedule contains digital feature presentation content (Step 600). The theatre central server 26 assembles the play list for that digital feature presentation content (Step 610) and reviews the remote devices to ensure all the digital feature presentation content is loaded on the specified feature presentation playback device storage device (Step 620). If loaded, theatre central server 26 queues the operator interface for manual start-up or automatically initiates the presentation playback device to start at the designated scheduled time and display of the digital feature presentation and associated trailer content. (Step 630). If it is not loaded, the theatre central server 26 scans the entire feature presentation playback device(s) and associated storage devices (Step 640). If the digital feature presentation and associated trailer content is not found, an alert is raised locally and the CMC. If the digital feature presentation and associated trailer content files are found, it moves the digital feature presentation content to the specified feature presentation playback device(s) (Step 650). The theatre central server 26 queues the operator interface for a manual start-up or automatically initiates the presentation playback device to start at the designated scheduled time and display of the digital feature presentation and associated trailer content. (Step 660).

It will be apparent to those skilled in the art that various modifications and variations can be made in the system and method of the present invention without departing from the spirit or scope of the invention. The present invention covers the modifications and variations of this invention provided they come within the scope of the appended claims and their equivalents.

What is claimed is:

1. A centralized content management system for communicating with and providing content to movie theatre complexes having a plurality of screens, said system comprising:
a central management assembly for assembling and transmitting data representative of digital content and an instruction set associated with the digital content;
a theatre complex assembly for receiving and storing the data and queuing the data pursuant to said instruction set, the theatre complex assembly including a matrix for routing said data to a selected one or more of said plurality of screens; and
a plurality of electronic display assemblies coupled to said matrix for displaying data received from said theatre complex assembly.

2. A centralized content management system as claimed in claim 1, wherein said theatre complex assembly includes a theatre server assembly having at least one video/graphics/audio card for outputting said data to said matrix.

3. A centralized content management system as claimed in claim 2, wherein each of said at least one video/graphics/audio cards includes one or more ports, each port being configured to output a unique data segment to the matrix.

4. The centralized content management system of claim 3 wherein said matrix includes a plurality of inputs and a plurality of outputs, each output being configured to route the unique data segment to one or more electronic display assemblies.

5. A centralized content management system as claimed in claim 1, wherein said theatre complex assembly is responsive to said instruction set for selecting certain stored data for transmission to a first digital projector of said electronic display assemblies.

6. A centralized content management system as claimed in claim 4, wherein the theatre server of said theatre complex assembly further receives information regarding an assigned location and a movie is to be shown in the theatre environment associated with said plurality of electronic display assemblies.

7. A centralized content management system as claimed in claim 1 further comprising a communication link between the central management assembly and the theatre complex assembly.

8. A centralized content management system as claimed in claim 7 wherein the communication link comprises a satellite uplink and downlink system and wherein the theatre complex assembly includes a catch server for receiving the data from a transmission server of the central management assembly.

9. The centralized content management system of claim 1 wherein the electronic display assemblies are lobby display devices

10. The centralized content management system of claim 9 wherein the lobby display devices are located in high traffic areas.

11. A centralized content management system permitting digital content to be displayed on multiple electronic displays at a plurality of movie theatre complexes according to a set of instructions, said system comprising:
at least one central management assembly including:
means for assembling the digital content to be displayed,
means for assembling the set of instructions associated with the digital content, and
means for transmitting the digital content and associated instruction set to one or more of the plurality of movie theatre complexes; and
a theatre complex assembly for each of the plurality of movie theatre complexes, the theatre complex assembly comprising a theatre server for receiving, storing and queuing the digital content pursuant to said set of instructions, and a matrix for routing the digital content to one or more of said multiple electronic displays.

12. The centralized content management of claim 11 wherein the electronic displays are lobby display devices.

13. The centralized content management system of claim 12 wherein the lobby display devices are located in high traffic areas.

14. The centralized content management system of claim 11 wherein the electronic displays are electronic movie display devices located in movie theaters.

15. The centralized content management system of claim 11 wherein the theatre server includes at least one video/audio/graphics card for outputting said digital content to said matrix.

16. The system of claim 15 wherein said matrix includes a plurality of inputs and a plurality of outputs, each output being configured to route the digital content segment to one or more electronic display devices.

17. The centralized content management system of claim 16 wherein said electronic display devises comprise a combination of digital movie projectors, plasma screens, monitors, video walls, and other like display devices

18. The centralized content management system of claim 11 further comprising an operator interface at each electronic display device, the operator interface being configured to permit the manual operation of the centralized content management system for the associated electronic display device.

19. The centralized content management system of claim 11 wherein the means for transmitting the digital content comprises a satellite link and wherein the theatre complex assembly further comprises a catch server for receiving and storing said digital content.

20. The system of claim 19 wherein the theatre server periodically polls the catch server and pulls the digital content from the catch server to the video server.

21. A method for managing and distributing digital content from a central location to remote movie theatre complexes, each complex having a plurality of screens, said method comprising the steps of:
assembling a digital content segment in a central management content assembly,
creating an associated instruction set for the digital content segment in the central management content assembly,
transmitting the digital content segment and the instruction set through a communication link to one or more of the movie theatre complexes,
queuing the digital content segment in each one of the one or more movie theatre complexes per the schedule context,
routing the digital content segment to one or more screens of the plurality of screens meeting the schedule context.

22. The method of claim 21 further comprising the step of:
displaying the digital content segment at the one or more screens of the plurality of screens meeting the schedule context.

23. The method of claim 21 wherein each movie theatre complex is provided with a theatre complex assembly, and wherein the step of queuing the digital content segment further comprises the steps of:
creating a movie schedule for a movie theatre complex,
storing the movie schedule on the theatre complex assembly,
comparing the instruction set with the movie schedule to determine the electronic display devices meeting the instruction set upon which to display the digital content segment.

24. A method for displaying a live digital feed to movie theatre complexes having a plurality of screens, said method comprising the steps of:
creating an instruction set for the live digital feed prior to a broadcast of the live digital feed,
storing the instruction set in a theatre server assembly for each theatre complex preselected to display the live digital feed,
receiving the live digital feed at one or more movie theatre complexes per the instruction set,
routing the digital feed to one or more screens of the plurality of screens meeting the instruction set, and
transmitting the schedule context through a communication link to one or more of the movie theatre complexes.

25. The method of claim 24 wherein the instruction set comprises the date and time of the live digital feed.

26. The method of claim 24 wherein the step of creating an instruction set comprises the steps of:
providing a theatre complex assembly for a movie theatre complex, the theatre complex assembly having a satellite receiver and a theatre server, and
creating an instruction set at the movie theatre complex assembly.

27. The method of claim 24 wherein the step of creating an instruction set comprises the steps of:
providing a central management content assembly serving a plurality of remote theatre complexes, the central management content assembly having a satellite communication link,
creating an instruction set for one or more of the remote theatre complexes at the central management content assembly,
transmitting the instruction set to one or more of the plurality of remote theatre complexes,
providing each theatre complex assembly with a satellite receiver and a theatre server, and
receiving the instruction set at the theatre complex assembly.
